(19) United States
(12) Patent Application Publication
(10) Pub. No.: US 2018/0325123 A1
(43) Pub. Date: Nov. 15, 2018

(54) Method and Device for Orienting Wound Dough Products Along a Decelerating Section

(71) Applicant: Fritsch GmbH, Markt Einersheim (DE)

(72) Inventor: Udo Bernhardt, Iphofen (DE)

(21) Appl. No.: 15/971,418

(22) Filed: May 4, 2018

(30) Foreign Application Priority Data
May 9, 2017 (DE) 10 2017 109 925.5

(51) Int. Cl. A21C 9/08; B65G 15/16

(52) U.S. Cl. CPC A21C 9/088; B65G 15/62; B65G 15/16; A21C 9/085

(57) ABSTRACT

A method for orienting wound dough products in a defined end position by winding a triangular or trapezoidal dough piece along a winding section includes winding from the base of the dough piece with the narrower end of the dough piece forming an end protruding outside at the circumference of the dough product. The end position of the dough product is defined by a position of the end protruding at the outside. The wound dough product is decelerated from a translational starting speed to a translational end speed along a decelerating section. The resulting deceleration torque is used as a driving torque for a rolling movement of the dough product. The rolling movement is stopped by resistance when the end of the dough product is in contact with the surface. The translational conveying speed and/or the speed of rotation of the wound dough product is changed in control section.

The invention relates to a method for orienting wound dough products in a defined end position according to the preamble of claim 1. Furthermore, the invention relates to a device for carrying out the method according to the invention.

From WO 2012/062267 A2, a generic method and a generic device for orienting wound dough products in a defined end position are known. Said method is used in particular to orient wound dough products wound from trapezoidal dough pieces, such as croissants, in a defined end position prior to baking. The method is based on the idea that the wound dough products, after having passed through the winding section, are decelerated from a translational starting speed to a changed translational intermediate speed. To this end, the wound dough products pass through a decelerating section. Because of the deceleration of the wound dough products, a deceleration torque acts on the dough products, which imparts a rolling movement to the dough products. Because of said rolling, the dough products roll on a surface with a sense of rotation that corresponds to the winding direction from the inside to the outside of the wound dough product. Upon arrival in the end position, in which the end of the dough product is in contact with the surface, the rolling movement is stopped by the rolling resistance caused by the end. As a result, a defined end position in which the end of the dough product is in contact with the surface can thus be easily reached owing to the deceleration of the dough products and to the related rolling of the dough products on the surface.

In order to orient the dough products in the defined end position by decelerating them along the decelerating section, relatively precise marginal conditions in terms of the starting and end speeds of the dough product have to be set so as to prevent the dough product from rolling over the end if the driving torque generated by the deceleration torque is too high, for example. Vice-versa, the driving torque generated by the deceleration torque must not be too small, either, because otherwise the rolling movement caused by the deceleration is not sufficient to reach the defined end position. The problem here is that the marginal conditions of deceleration along the decelerating section could not be freely selected so far. In particular, the starting speed of the dough product when leaving the winding section is highly dependent on the production speed desired in each case because at higher clock frequencies the dough products are transported through the winding section at increasingly higher speeds. Moreover, the higher clock frequencies cause an increase in the speed of rotation of the dough pieces when the dough pieces leave the winding section. The fast rotation of the dough pieces when leaving the winding section also causes the dough pieces to wobble, which often makes defined deceleration of the dough pieces immediately after leaving the winding section impossible.

Based on this state of the art, the object of the present invention thus is to propose a method and a device for orienting wound dough products by deceleration in a decelerating section, wherein very high clock frequencies are also made possible. In particular, the high reject rate which occurs in the operation of known devices at high clock frequencies is to be reduced as well.

This object is attained by a method and by a device according to the teaching of the two independent main claims.

Advantageous embodiments of the invention are the subject-matter of the dependent claims.

The method according to the invention is based on the idea that an additional control section is provided between the end of the winding section and the start of the decelerating section, the wound dough products passing through said control section. In the control section, it is provided for the translational conveying speed of the wound dough products and/or the speed of rotation of the wound dough products to be changed. In particular, this allows the translational conveying speed waiting at the end of the winding section and the speed of rotation of the wound dough products, which is highly dependent on the respective production frequency during winding, to be changed and adjusted in such a manner that the marginal conditions set in the control section subsequently allow the defined end position to be reached when the dough products are decelerated in the decelerating section.

The manner in which the translational conveying speed and the speed of rotation of the wound dough products are changed is basically optional. It is particularly advantageous for the translational conveying speed and the speed of rotation of the wound dough product to be set to a predefined target value in the control section.

A very important factor for the correct deceleration of the dough products in the decelerating section and the thus achieved setting of the defined end position within a specific range is the speed of rotation of the wound dough products. It is this speed of rotation of the wound dough products that is greatly increased by an increase in clock frequency in the winding section, which, however, makes correct deceleration of the dough products in the decelerating section for setting the defined end position significantly more difficult. This is because the wound dough products tumble uncontrollably when leaving the winding device at high clock frequencies in the state of the art. Hence, it is particularly advantageous for the speed of rotation of the wound dough products to be decelerated in the control section so that the starting speed possible at maximum for decelerating when setting the defined end position in the decelerating section is not exceeded.

The degree to which the speed of rotation of the wound dough products is decelerated in the control section depends on the production quality during deceleration in the decelerating section. It is particularly advantageous if the speed of rotation of the wound dough products is decelerated to a value of zero in the control section, i.e. the dough products do no longer rotate by themselves at the end of the control section.

Alternatively, the speed of rotation of the wound dough product in the control section can also be reversed in the opposite direction in such a manner that this rotating movement in the reverse direction corresponds to just the rotating movement during deceleration in the decelerating section. Thus, the required deceleration torque can be significantly reduced.

The manner in which the wound dough products are decelerated in the decelerating section is basically optional. When a control section is used as provided according to the invention, this can be brought about in a particularly simple manner by transferring the dough products from a first conveyor band, which is driven to circulate at a first conveying speed, to a second conveyor band, which is driven to circulate at a second conveying speed. The corresponding difference between the first conveying speed and the second conveying speed allows the wound dough products to be decelerated in transfer, whereby the desired rolling movement is imparted to the wound dough products. To be able to more easily impart the rolling movement to the wound dough products during transfer from the first conveyor band to the second conveyor band, it is particularly advantageous if the wound dough products are displaced vertically downward in the decelerating section when they are transferred from the first conveyor band to the second conveyor band. This small drop of the wound dough products during transfer from the first conveyor band to the second conveyor band increases the rolling impulse, and reproducible process conditions are created. The device according to the invention for carrying out the method according to the invention when orienting wound dough products generically comprises a winding section and a decelerating section. In the winding section, the dough pieces are wound to form dough products. In the downstream decelerating section, a rolling movement can be imparted to the wound dough products by decelerating them accordingly so as to make the defined end position possible in which the end of the dough product is in contact with the surface.

The device according to the invention is characterized by a conveyor which forms a control section between the winding section and the decelerating section. The conveyor is characterized in that the translational conveying speed of the wound dough products and the speed of rotation of the wound dough products can be changed as the wound dough products pass through the control section between the winding section and the decelerating section.

The constructional design of the conveyor forming the control section is basically optional. In a particularly simple manner, the conveyor can be formed by two conveyor bands driven to circulate, the first conveyor band engaging the wound dough products from below and the second conveyor band engaging the wound dough products from above. By suitably setting the speed of circulation of the first conveyor band relative to the speed of circulation of the second conveyor band, the translational conveying speed of the dough product and the speed of rotation of the wound dough product can be changed in the desired way and, if applicable, can be set to a predefined target value owing to the simultaneous engagement of the two conveyor bands.

To allow simple adjustment of the translational conveying speed and of the speed of rotation of the wound dough product set in the control section, it is particularly advantageous if the speed of circulation of the first conveyor band and/or the speed of circulation of the second conveyor band can be set independently of each other.

During winding of the dough pieces, it can happen that the wound dough products are displaced to the right or to the left from the desired center position. These positional defects of the wound dough products are disadvantageous for the subsequent production stages if, for example, the wound dough products are supposed to subsequently be bent in order to produce traditional croissants. To be able to correct these positional defects in a simple manner without large additional effort, it is particularly advantageous if the upper conveyor band of the conveyor is composed of at least two spaced-apart conveyor belts, each of the two conveyor belts being in contact with the wound dough product eccentrically. By means of the two spaced-apart conveyor belts, a centering movement of the wound dough products during their passage through the control section is achieved. Specifically, if the wound dough pieces having a positional defect are located a little too far to the left or to the right of the desired center line, the resulting height difference on the left or on the right side in relation to either one of the conveyor belts in contact with the dough pieces causes the wound dough pieces to be pushed in the direction of the desired center position. For the control section and the decelerating section disposed downstream thereof to be constructionally realized with means as simple as possible, it is particularly advantageous if, for forming the deceleration section, a conveyor band having a low conveying speed is disposed downstream of the lower conveyor band of the control section. Thus, the decelerating section will be formed by the fact that the wound dough products are transferred from the lower conveyor band of the control section to the downstream conveyor band having the lower conveying speed. Because of the difference between the conveying speeds during transfer from the lower conveyor band of the control section to the conveyor band disposed downstream thereof, the dough products are decelerated and the thus caused deceleration torque causes the desired rolling movement.

To further increase the rolling impulse, it is particularly advantageous if a downward vertical height difference is provided between the lower conveyor band of the control section and the conveyor band of the decelerating section disposed downstream thereof so that the dough products drop a small distance when they are transferred from the lower conveyor band of the control section to the downstream conveyor band.

An embodiment of the invention is schematically illustrated in the drawing and will be explained in more detail below.

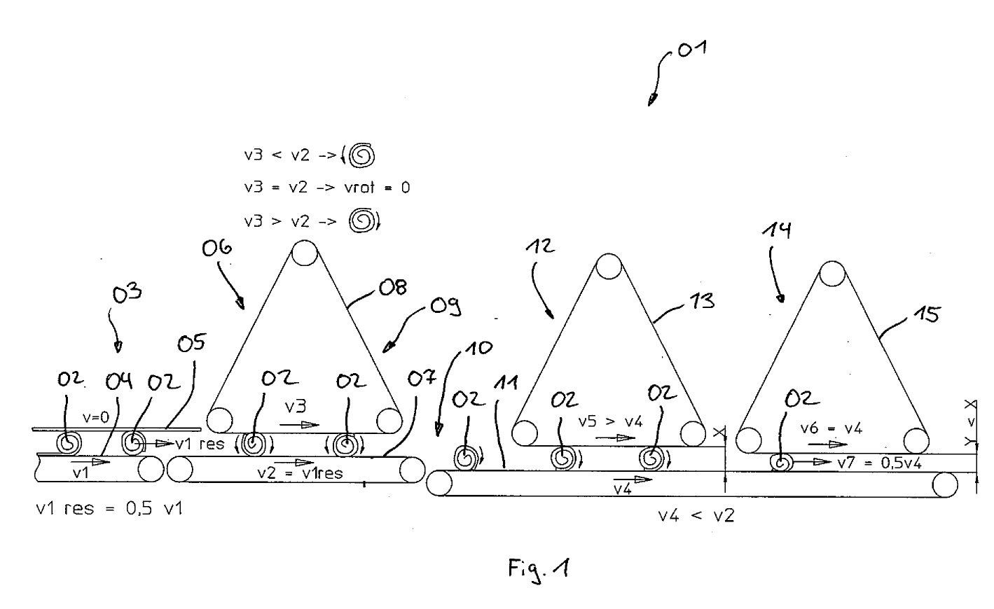

FIG. 1 shows a side view of a schematically illustrated installation for winding and orienting dough products in a defined end position;

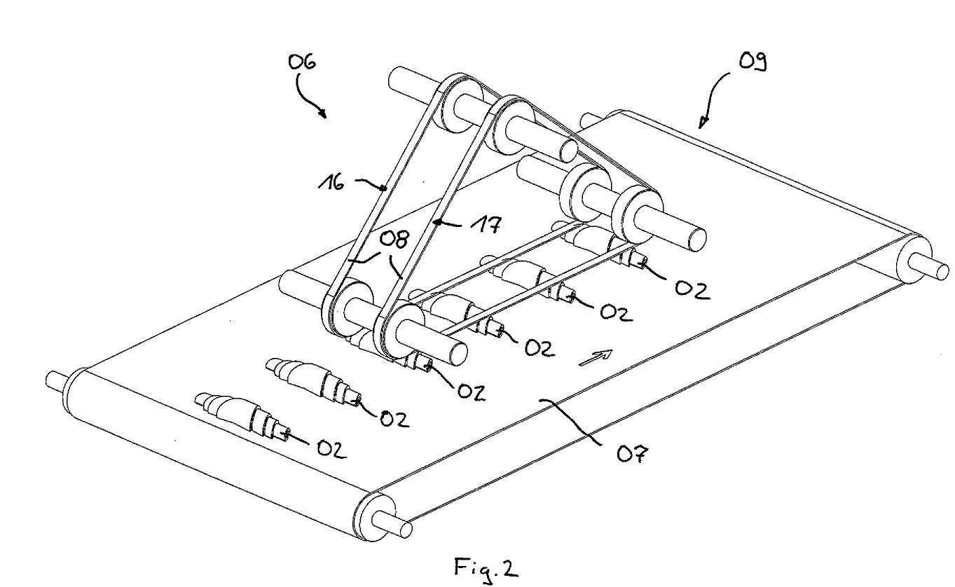

FIG. 2 shows a perspective top view of a conveyor disposed as a control section between the winding section and the decelerating section of the installation according to FIG. 1.

FIG. 1 shows a device 01 for winding and orienting dough products 02 in a defined end position. The device 01 comprises a winding section 03 in which the dough products 02 are produced by winding triangular or trapezoidal dough pieces. In the winding section 03, the dough products 02 are transported on a conveyor band 04 in a conveying direction, the upper apexes of the dough products 02 being in contact with a fixed winding plate 05. Effectively, this means that the dough products 02, at their lower apex, are moved with a conveying speed that corresponds to the speed of circulation v1 of the conveyor band 04, whereas the upper apex of the dough products 02 has a speed of zero. Owing to the difference in speed between the winding plate 05 and the conveyor band 04, a rotating winding movement is imparted to the dough products 02, the dough products 02 thus having a translational conveying speed vires at the end of the winding section 03. The winding section 03 is followed by a control section 06 which is formed by a lower conveyor band 07 and an upper conveyor band 08. Conveyor band 07 circulates at a conveying speed v2, v2 corresponding to just the translational conveying speed vires of the dough products 02 at the end of the winding section 03. The speed of circulation of conveyor band 08 can be variably set, resulting in a corresponding rotation of the dough products 02 as a function of the speed of circulation v3 of conveyor band 08 relative to the speed of circulation v2 of conveyor band 07. If the speed of circulation v3 of conveyor band 08 corresponds to just the speed of circulation v2 of conveyor band 07, the dough products 02 no longer have a speed of rotation and are moved in the conveying direction with a translational conveying speed of v2=v3. If v3 is selected to be a little less than v2, the dough products 02 rotate counterclockwise, whereas the dough products 02 rotate clockwise if v3 is a little greater than v2. As a result, the speed of rotation of the dough products 02 can thus be easily set by selecting the ratio of v2:v3. The translational conveying speed of the dough products 02 can be similarly set by selecting v2 and v3.

As a result, the conveyor 09 formed by the conveyor bands 07 and 08 and forming the control section 06 allows the dough products 02 leaving the winding section 03 to be precisely set in terms of their translational conveying speed and their speed of rotation, the conditions for orienting the dough products 02 in the decelerating section 10 disposed downstream thus being optimized.

In the device 01, the decelerating section 10 is realized by the transition from conveyor band 07 to a downstream conveyor band 11. Conveyor band 11 is driven at a speed of circulation v4 that is smaller than the speed of circulation v2 of conveyor band 07. Because of this difference in speed between the conveyor bands 07 and 11, the dough products 02 are translationally decelerated when they are transferred from conveyor band 07 to conveyor band 11 and a rolling movement is simultaneously imparted to the dough products 02 by the deceleration torque. This rolling movement is increased by the fact that a small vertical height difference is provided between conveyor band 11 and conveyor band 07, which causes the dough products to drop a small distance when transitioning from conveyor band 07 to conveyor band 11. Owing to the rolling movement caused by the deceleration torque, the dough products 02 roll clockwise for a small distance on conveyor band 11 until the rolling resistance caused by the ends of the dough products stops the rolling in the defined end position, in which the end of the dough product is in contact with the surface, namely with conveyor band 11. As a result, a rolling movement is thus imparted to the dough product 02 when it is transferred from conveyor band 07 to conveyor band 11 until it has reached the defined end position, in which the end of the dough product is in contact with the upper side of conveyor band 11 because of the clockwise rolling motion.

Subsequently, the dough products 02 pass through an orientation section 12 which is formed by the interaction of conveyor band 11 with a conveyor band 13. Conveyor band 13 is driven at a speed of circulation v5 that is slightly greater than the speed of circulation v4 of conveyor band 11. This difference in speed between v5 and v4 helps achieve that the dough products 02 continue to rotate clockwise by about 45° along the orientation section 12, their ends thus coming into contact with the upper surface of conveyor band 11. The orientation section 12 is followed by a flattening section 14. The flattening section 14 is formed by conveyor band 11 interacting with a conveyor band 15. The vertical distance Y between conveyor band 11 and conveyor band 15 is smaller than the diameter X of the dough products 02, the dough products 02 thus being vertically flattened in the flattening section 14 so as to secure the position of the end in the defined end position.

FIG. 2 shows the control section 06 with the conveyor 09 in a perspective view at an angle from above. The conveyor 09 is composed of conveyor band 07 and conveyor band 08. Conveyor band 08 itself is composed of two spaced-apart conveyor belts 16 and 17, which engage the wound dough products 02 eccentrically. The distance between the two conveyor belts 16 and 17 leads to a centering of the dough products 02 centrally between the two conveyor belts 16 and 17.

1. A method for orienting wound dough products in a defined end position, the dough product being produced by winding a triangular or trapezoidal dough piece along a winding section, and the dough product being wound starting from the base of the dough piece, and the narrower end of the dough piece forming an end protruding outside at the circumference of the dough product, and the end position of the dough product being defined by a specific position of the end protruding at the outside, and the wound dough product being decelerated from a translational starting speed to a translational end speed along a decelerating section, and the resulting deceleration torque being used as a driving torque for a rolling movement of the dough product so as to cause the dough product to roll on a surface, the sense of rotation of the rolling movement of the dough product corresponding to the winding direction from the inside to the outside of the wound dough product, and the rolling movement being stopped by the rolling resistance caused by the end when the defined end position, in which the end of the dough product is in contact with the surface, is reached, wherein
the wound dough product passes through a control section between the end of the winding section and the start of the deceleration section, the translational conveying speed of the wound dough product and/or the speed of rotation of the wound dough product being changed in the control section.

2. The method according to claim 1, wherein
the translational conveying speed of the wound dough product and/or the speed of rotation of the wound dough product are set to a predefined target value in the control section.

3. The method according to claim 1, wherein
the speed of rotation of the wound dough product is decelerated in the control section.

4. The method according to claim 3, wherein
the speed of rotation of the wound dough product is decelerated to zero in the control section.

5. The method according to claim 3, wherein
the speed of rotation of the wound dough product is reversed in the opposite direction in the control section, the rotating movement in the opposite direction corresponding to the rotating movement during deceleration in the decelerating section.

6. The method according to any one of claim 1, wherein
in the decelerating section, the wound dough product is decelerated by being transferred from a first conveyor band, which is driven to circulate at a first conveying speed, to a second conveyor band, which is driven to circulate at a second conveying speed, whereby the desired rolling movement is imparted to the wound dough product.

7. The method according to claim 6, wherein in the decelerating section, the wound dough product is displaced vertically downward when being transferred from the first conveyor band to the second conveyor band.

8. A device for carrying out a method for orienting wound dough products in a defined end position, the device comprising a winding section in which dough pieces are wound to form dough products and a decelerating section in which the dough products are decelerated in a defined end position, wherein
the device has a conveyor for forming a control section between the winding section and the decelerating section, the translational conveying speed of the wound dough product and/or the speed of rotation of the wound dough product being changeable in the control sectiones between the winding section and the decelerating section using the conveyor.

9. The device according to claim 8, wherein
the conveyor between the winding section and the decelerating section is formed by two conveyor bands which are driven to circulate, the first conveyor band engaging the wound dough products from below and the second conveyor band engaging the wound dough products from above, and the translational conveying speed of the wound dough product and/or the speed of rotation of the wound dough product being changeable by adjusting the speed of circulation of the first conveyor band and/or by adjusting the speed of circulation of the second conveyor band.

10. The device according to claim 9, wherein
the speed of circulation of the first conveyor band and the speed of circulation of the second conveyor band can be adjusted independently of each other.

11. The device according to claim 9, wherein
the upper conveyor band of the conveyor consists of at least two spaced-apart conveyor belts, each of the two conveyor belts coming into contact with the dough product eccentrically.

12. The device according to claim 8, wherein
to form the decelerating section, a conveyor band having a lower conveying speed is disposed downstream of the lower conveyor band of the control section, the wound dough products being decelerated owing to the difference between the conveying speeds when being transferred from the lower conveyor band of the control sectiones to the conveyor band of the decelerating section disposed downstream of said lower conveyor band, whereby the desired rolling movement is imparted to the wound dough products.

13. The device according to claim 8, wherein
a downward vertical height difference is provided between the lower conveyor band of the control section and conveyor band of the decelerating section disposed downstream of said lower conveyor band.
